(19) United States
(12) Patent Application Publication
(10) Pub. No.: US 2025/0153119 A1
(43) Pub. Date: May 15, 2025

(54) STIRRING DEVICE AND STIRRING METHOD

(71) Applicant: SUMITOMO HEAVY INDUSTRIES PROCESS EQUIPMENT CO., LTD., Saijo-shi (JP)

(72) Inventors: Naotaka MAEDA, Saijo-shi (JP); Hiroo HORIGUCHI, Saijo-shi (JP); Junichi TSUBONO, Saijo-shi (JP)

(21) Appl. No.: 19/021,163

(22) Filed: Jan. 15, 2025

Related U.S. Application Data
(63) Continuation of application No. PCT/JP2023/020292, filed on May 31, 2023.

(30) Foreign Application Priority Data
Jul. 29, 2022 (JP) 2022-121386

(51) Int. Cl. B01F 27/192; B01F 27/09; B01F 27/112; B01F 27/1145; B01F 27/906; B01F 27/92

(52) U.S. Cl. CPC B01F 27/1921; B01F 27/09; B01F 27/112; B01F 27/1145; B01F 27/906; B01F 27/92; B01F 2215/0422; B01F 2215/0427; B01F 2215/0431; B01F 2215/0495

(57) ABSTRACT

A stirring device includes: a stirring tank that accommodates a fluid; a fluid blade that is rotated to make the fluid flow in the stirring tank; and a stirring blade that is provided between a bottom portion of the stirring tank and the fluid blade, is rotated to stir the fluid, and includes a substantially-plate-shaped blade portion that extends from a rotary shaft of the stirring blade to a side wall of the stirring tank, in which a normal direction of a stirring surface of the substantially-plate-shaped blade portion is inclined with respect to both an axial direction of the rotary shaft and a rotation direction of the blade portion, and a blade diameter of the substantially-plate-shaped blade portion in an extension direction is between about 50% and 70% of a tank diameter of the stirring tank.

### CROSS-REFERENCE TO RELATED APPLICATIONS

This is a bypass continuation of International PCT Application No. PCT/JP2023/020292, filed on May 31, 2023, which claims priority to Japanese Patent Application No. 2022-121386, filed on Jul. 29, 2022, which are incorporated by reference herein in their entirety.

### BACKGROUND

### Technical Field

Certain embodiments of the present invention relate to a stirring device and the like.

### Description of Related Art

As a stirring device that stirs a fluid in a stirring tank, a stirring device including a fluid blade and a disc-shaped shear blade (dispersion blade) is disclosed in the related art. The dispersion blade provided at a central position that is in contact with a flow formed by the rotation of the fluid blade effectively shears the fluid.

### SUMMARY

According to an embodiment of the present invention, there is provided a stirring device including: a stirring tank that accommodates a fluid; a fluid blade that is rotated to make the fluid flow in the stirring tank; and a stirring blade that is provided between a bottom portion of the stirring tank and the fluid blade, is rotated to stir the fluid, and includes a substantially-plate-shaped blade portion that extends from a rotary shaft of the stirring blade to a side wall of the stirring tank, in which a normal direction of a stirring surface of the substantially-plate-shaped blade portion is inclined with respect to both an axial direction of the rotary shaft and a rotation direction of the blade portion, and a blade diameter of the substantially-plate-shaped blade portion in an extension direction is between about 50% and 70% of a tank diameter of the stirring tank.

According to another embodiment of the present invention, there is provided a stirring method. The stirring method includes: rotating a fluid blade to make a fluid flow in a stirring tank; and rotating a stirring blade, which is provided between a bottom portion of the stirring tank and the fluid blade and includes a substantially-plate-shaped blade portion that extends from a rotary shaft of the stirring blade to a side wall of the stirring tank, at a higher speed than the fluid blade to stir the fluid, in which a normal direction of a stirring surface of the substantially-plate-shaped blade portion is inclined with respect to both an axial direction of the rotary shaft and a rotation direction of the blade portion, and a blade diameter of the substantially-plate-shaped blade portion in an extension direction is between about 50% and 70% of a tank diameter of the stirring tank.

### BRIEF DESCRIPTION OF THE DRAWINGS

FIG. 1 is a vertical cross-sectional view showing a stirring device.

FIG. 2 is a perspective view showing a shear blade as viewed from a substantially side surface.

FIG. 3 is a top view or a bottom view showing the shear blade.

FIG. 4 is a perspective view showing a shear blade rotary shaft.

### DETAILED DESCRIPTION

The dispersion blade disclosed in the related art has a disc shape. Therefore, when a blade diameter is increased, load power increases, and it is difficult to maintain a rotational balance. Therefore, the blade diameter of the dispersion blade disclosed in the related art needs to be reduced. Specifically, as described in paragraph 0031 of the related art, the blade diameter of the dispersion blade is set between 10% and 30% of the tank diameter of the stirring tank. In this case, for example, when the viscosity of the fluid to be stirred by the stirring device is increased, the blade diameter of the dispersion blade needs to be further reduced due to a power issue, and there is a concern that the fluid will be less likely to reach the dispersion blade having a small diameter.

It is desirable to provide a stirring device and the like that can effectively stir even a high-viscosity fluid or a high-thixotropy fluid.

In this aspect, the non-disc-shaped stirring blade including the blade portion extending from the rotary shaft to the side wall of the stirring tank is used. Therefore, it is not necessary to reduce a blade diameter unlike the disc-shaped dispersion blade disclosed in the related art. As described above, the flow generated by the fluid blade can easily reach the stirring blade whose diameter can be increased as compared to the related art. Therefore, even a high-viscosity fluid is effectively stirred.

Any combination of the above-described components and configurations obtained by converting these expressions into methods, devices, systems, recording media, computer programs, and the like are also included in the embodiment of the present invention.

Hereinafter, a mode for carrying out the present invention (hereinafter, also referred to as an embodiment) will be described in detail with reference to the drawings. In the description and/or the drawings, the same or equivalent components, members, processes, and the like are denoted by the same reference numerals, and a duplicate description thereof will be omitted. The scale and shape of each portion shown in the drawings are set for convenience in order to simplify the description and are not limitedly interpreted unless otherwise specified. The embodiment is illustrative and does not limit the scope of the present invention in any way. All features described in the embodiment and combinations thereof are not necessarily essential to the present invention.

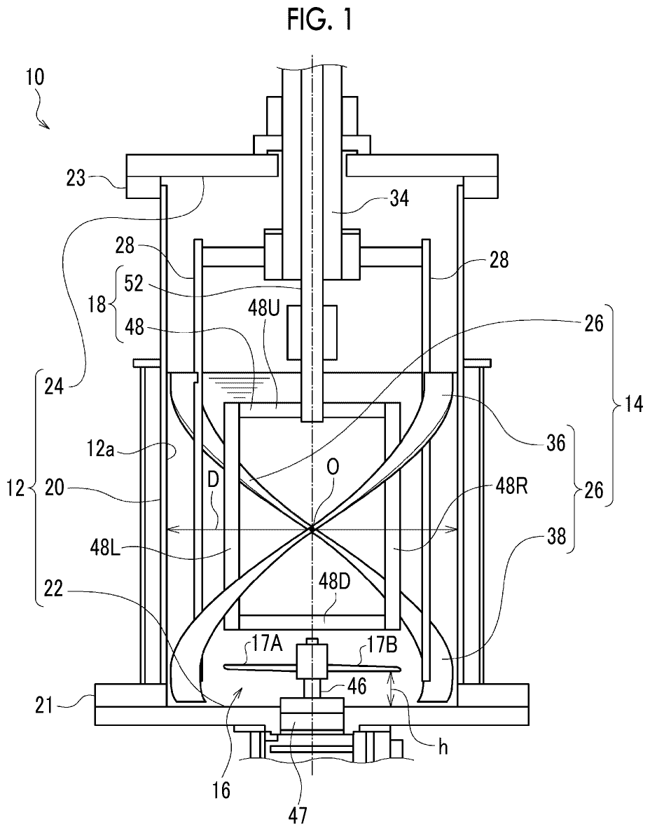

FIG. 1 is a vertical cross-sectional view showing a stirring device 10 according to the embodiment of the present invention. In the present embodiment, it is assumed that the stirring device 10 is installed in a vertical direction which is an up-down direction or a longitudinal direction in FIG. 1. The up-down direction, the longitudinal direction, and the vertical direction are used synonymously, and a left-right direction, a lateral direction, and a horizontal direction are used synonymously. In addition, the present invention is also applicable to a stirring device 10 that is not installed in the vertical direction. In this case, the vertical direction is different from the up-down direction and the longitudinal direction, and the horizontal direction is different from the left-right direction and the lateral direction. Further, each of rotary shafts of respective blades, such as a fluid blade rotary shaft 34 of a fluid blade 14, a shear blade rotary shaft 46 of a shear blade 16, and a gate blade rotary shaft 52 of a gate blade 18, is provided in the up-down direction, the longitudinal direction, and the vertical direction, which will be described below. Therefore, the up-down direction, the longitudinal direction, and the vertical direction are also referred to as an axial direction. Furthermore, the left-right direction, the lateral direction, and the horizontal direction are also referred to as a radial direction since they determine diameters of a stirring tank 12, the fluid blade 14, the shear blade 16, the gate blade 18, and the like.

The stirring device 10 includes the stirring tank 12 that accommodates a fluid to be stirred and the fluid blade 14, the shear blade 16, and the gate blade 18 as rotary blades that are rotatable about the rotary shafts 34, 46, and 52 in the axial direction in the stirring tank 12. The stirring tank 12 includes a cylindrical or tubular barrel portion 20 that is provided on the upper side and extends in the axial direction, a bottom portion 22 that is provided on the lower side to be continuous with the barrel portion 20, and a top portion 24 that is provided on the upper side to be continuous with the barrel portion 20. The bottom portion 22 of the stirring tank 12 in the present embodiment has a planar shape having the axial direction as a normal direction. When the bottom portion 22 is formed in the planar shape, there is an advantage that the distance to the shear blade 16 in the axial direction can be reduced, which will be described below. However, the present invention is applicable to the stirring tank 12 having the bottom portion 22 with any shape such as a curved surface shape or a reverse conical shape as in the related art.

The planar bottom portion 22 of the stirring tank 12 is attachable to a flange portion 21 that is formed in a cylindrical side wall 12a of the stirring tank 12 or the bottom portion or lowermost portion of the barrel portion 20 to protrude in the radial direction. That is, when the stirring tank 12 is assembled, the plate-shaped bottom portion 22 may be brought into contact with the flange portion 21 of the barrel portion 20 from the lower side and may be fixed by a fixing tool such as a screw. In this case, the shear blade 16, the shear blade rotary shaft 46, a shear blade driving unit 47, and the like which will be described below may be attached to the bottom portion 22 in advance. Alternatively, the shear blade 16, the shear blade rotary shaft 46, the shear blade driving unit 47, and the like may be attached to the bottom portion 22 after the bottom portion 22 is attached to the flange portion 21. When the bottom portion 22 of the stirring tank 12 is formed in the planar shape as described above, it is possible to improve the assemblability of the stirring tank 12 and the stirring device 10.

Similarly to the bottom portion 22, the top portion 24 of the stirring tank 12 in the present embodiment has a planar shape having the axial direction as the normal direction. The planar top portion 24 of the stirring tank 12 is attachable to a flange portion 23 that is formed in the cylindrical side wall 12a of the stirring tank 12 or the top portion or uppermost portion of the barrel portion 20 to protrude in the radial direction. That is, when the stirring tank 12 is assembled, the plate-shaped top portion 24 may be brought into contact with the flange portion 23 of the barrel portion 20 from the upper side and may be fixed by the fixing tool such as the screw. In this case, the fluid blade 14, the fluid blade rotary shaft 34, a fluid blade driving unit (not shown) that is provided on the upper side in FIG. 1, the gate blade 18, the gate blade rotary shaft 52, a gate blade driving unit (not shown) that is provided on the upper side in FIG. 1, and the like which will be described below may be attached to the top portion 24 in advance. Alternatively, the fluid blade 14, the fluid blade rotary shaft 34, the fluid blade driving unit, the gate blade 18, the gate blade rotary shaft 52, the gate blade driving unit, and the like may be attached to the top portion 24 after the top portion 24 is attached to the flange portion 23.

An inner peripheral wall or the side wall 12a of the barrel portion 20 of the stirring tank 12 has a circular cross section in a top view, and a diameter D thereof is hereinafter also referred to as a tank diameter D. In addition, the cross section of the barrel portion 20 and/or the stirring tank 12 in a top view may have any non-circular shape. In this case, the tank diameter D of the stirring tank 12 may be a diameter of an inscribed circle of the cross-sectional shape, a diameter of a circumscribed circle of the cross-sectional shape, or an average value or an intermediate value of the diameters. At least a part of the upper portion of the barrel portion 20 is open such that the fluid to be stirred can be injected, and can be closed by a lid or the like during the stirring of the fluid by the stirring device 10. In addition, the fluid to be stirred may be supplied into the stirring tank 12 through a fluid supply port, such as a supply nozzle, provided in a side surface of the barrel portion 20.

The fluid blade 14, the shear blade 16, and the gate blade 18 are individually driven to be rotated about the rotary shafts in the vertical direction (the up-down direction in FIG. 1) by driving units, such as motors or speed reducers, provided outside the stirring tank 12. Further, the fluid blade rotary shaft 34 of the fluid blade 14, the shear blade rotary shaft 46 of the shear blade 16, and the gate blade rotary shaft 52 of the gate blade 18 may not be provided on the same straight line unlike the example shown in FIG. 1, and the directions thereof may be different from each other. The rotation directions and rotation speeds of the fluid blade 14, the shear blade 16, and the gate blade 18 can be independently set or controlled and are optimally set or controlled in consideration of various conditions such as the capacity or shape of the stirring tank 12, the properties of the fluid in the stirring tank 12, and the speed or phase of a chemical reaction to occur in the stirring tank 12.

Typically, the rotation speed of the shear blade 16 that is responsible for shearing or refining the fluid, fine particles in the fluid, agglomerates of the fluid, and the like is higher than the rotation speed of the fluid blade 14 and/or the gate blade 18 that is responsible for the flow of the fluid. For example, while the typical rotation speed of the fluid blade 14 is 20 to 30 [rpm] in a case where the capacity of the stirring tank 12 is about 10 [l], it is preferable that the rotation speed of the shear blade 16 is about 1,200 [rpm]. In addition, while the typical rotation speed of the fluid blade 14 is 20 to 30 [rpm] in a case where the capacity of the stirring tank 12 is about 1,000 [l], it is preferable that the rotation speed of the shear blade 16 is 600 to 900 [rpm]. As described above, it is preferable that the rotation speed of the shear blade 16 is at least 20 times the rotation speed of the fluid blade 14. In addition, a rotation speed of about 3,600 [rpm] is required in order to obtain the shear performance equivalent to that of the large-diameter shear blade 16 in the present embodiment with the small-diameter dispersion blade disclosed in the related art. According to the shear blade 16 whose diameter can be increased as described below, the rotation speed for obtaining the desired shear performance or refinement performance is reduced. Therefore, the low-power shear blade driving unit 47 is adopted, which makes it possible to reduce the size or cost of the stirring device 10.

The fluid blade rotary shaft 34 of the fluid blade 14 is formed in a cylindrical shape or a tubular shape, and the gate blade rotary shaft 52 of the gate blade 18 is inserted into the fluid blade rotary shaft 34. The fluid blade rotary shaft 34 of the fluid blade 14 and the gate blade rotary shaft 52 of the gate blade 18 extend from the top portion 24 of the stirring tank 12 to the inside of the stirring tank 12. The fluid blade rotary shaft 34 is driven to be rotated by the fluid blade driving unit (not shown) that is provided on the upper side in FIG. 1, and the gate blade rotary shaft 52 is driven to be rotated in the fluid blade rotary shaft 34 by the gate blade driving unit (not shown) that is provided on the upper side in FIG. 1. It is preferable that the fluid blade driving unit and the gate blade driving unit are configured by different motors. However, it is preferable that the fluid blade driving unit and the gate blade driving unit are integrally configured as one driving unit including the plurality of motors.

The shear blade rotary shaft 46 of the shear blade 16 serving as the stirring blade extends from the bottom portion 22 of the stirring tank 12 to the inside of the stirring tank 12. The shear blade rotary shaft 46 is driven to be rotated by the shear blade driving unit 47 that is provided on the lower side in FIG. 1. A driving unit that constitutes the shear blade driving unit 47 and is provided below the stirring tank 12 is different from a driving unit that constitutes the fluid blade driving unit and/or the gate blade driving unit and is provided above the stirring tank 12.

The fluid blade 14 is rotated about the fluid blade rotary shaft 34 by the fluid blade driving unit to make the fluid flow in the stirring tank 12. The fluid blade 14 in the shown example is a pair of ribbon blades formed in a spiral shape around the fluid blade rotary shaft 34 in the vertical direction. In addition, the shape of the fluid blade 14 is not limited to the spiral shape or the ribbon shape, and it is preferable that the fluid blade 14 has a shape in which a portion close to the bottom portion 22 is small in order to secure a sufficient space for installing the shear blade 16 (which will be described below) in a region facing the bottom portion 22 of the stirring tank 12. Therefore, the ribbon blade in the shown example is preferable to an anchor blade having a shape along the bottom portion 22.

In addition, the ribbon blade in the shown example faces the bottom portion 22 at a location close to the side wall 12a of the stirring tank 12. However, since the shear blade 16 is installed in a central region of the stirring tank 12 in the radial direction (a region around a rotary shaft such as the shear blade rotary shaft 46), the fluid blade 14 (ribbon blade) and the shear blade 16 (stirring blade) do not interfere with each other, which will be described below. In many cases, the fluid to be stirred settles and a discharge port through which the stirred fluid is discharged is provided in the bottom portion 22 of the stirring tank 12. An excellent balance between the flow of the fluid by the fluid blade 14 and the shearing (stirring) by the shear blade 16 is required. As in the shown example, the configuration in which the fluid blade 14 is rotated in an outer peripheral region of the bottom portion 22 and the shear blade 16 is rotated in the central region of the bottom portion 22 is adopted, which makes it possible to improve the quality of the stirred fluid in the bottom portion 22. In addition, since the fluid blade 14 is present only in the outer peripheral region of the bottom portion 22, it is possible to increase the diameter of the shear blade 16 in the central region of the bottom portion 22.

When the fluid blade 14 is rotated integrally with the fluid blade rotary shaft 34 by the fluid blade driving unit, an induced flow is formed in a downward direction along the side wall 12a of the barrel portion 20. The fluid carried by the induced flow in the stirring tank 12 moves to the bottom portion 22, is guided from the outer peripheral region to the central region in which the shear blade 16 is present, and is efficiently sheared or stirred.

The fluid blade 14 includes a plurality of (two in the example shown in FIG. 1) strip-shaped fluid blade bodies 26 having a predetermined width and a plurality of (two in the example shown in FIG. 1) support rods 28 that are engaged with inner peripheral portions of upper and lower end portions of the respective fluid blade bodies 26. The plurality of fluid blade bodies 26 and the plurality of support rods 28 are integrated with each other by welding or the like in a state in which they are combined as shown in FIG. 1. Each support rod 28 is a rod-shaped member that extends in the axial direction, and the upper and lower end portions of each fluid blade body 26 are engaged with the support rod 28 to be supported.

In the example shown in FIG. 1 in which two support rods 28 and two fluid blade bodies 26 are provided, an upper end portion of an upper blade 36 of the first fluid blade body 26 is engaged with an upper end portion of the first support rod 28, and a lower end portion of a lower blade 38 of the second fluid blade body 26 is engaged with a lower end portion of the first support rod 28. Similarly, an upper end portion of the upper blade 36 of the second fluid blade body 26 is engaged with an upper portion of the second support rod 28, and a lower end portion of the lower blade 38 of the first fluid blade body 26 is engaged with a lower portion of the second support rod 28. As described above, the fluid blade bodies 26 that are engaged with the upper and lower portions of the respective support rods 28 are different from each other. In other words, a plurality of different fluid blade bodies 26 are engaged with the respective support rods 28, and the respective fluid blade bodies 26 are engaged with a plurality of different support rods 28.

In addition, other (for example, two) support rods 28 may be further provided at an intermediate position between the two support rods 28 shown in FIG. 1 on the same circumference in a top view. The two support rods 28 provided on the front and rear sides of paper shown in FIG. 1 support or guide a central portion of each fluid blade body 26 in the axial direction, which is represented by O, to maintain each fluid blade body 26 in a desired spiral shape. The upper end of each support rod 28 is connected to the fluid blade rotary shaft 34 in the vertical direction. When the fluid blade rotary shaft 34 is driven to be rotated by the fluid blade driving unit (not shown), the fluid blade 14 including the support rods 28 and the fluid blade bodies 26 connected to each other is integrally rotated to form the downward induced flow.

The two fluid blade bodies 26 formed in a spiral strip shape as a whole are formed to be point-symmetric with respect to the fluid blade rotary shaft 34 in a top view. Each of the fluid blade bodies 26 is formed to turn 180 degrees about the fluid blade rotary shaft 34 in a top view. Therefore, as described above, the upper end portion of each of the fluid blade bodies 26 is engaged with one support rod 28, and the lower end portion of the fluid blade body 26 is engaged with the other support rod 28 at a position (a position rotated 180 degrees) that is point-symmetric to the one support rod 28 with respect to the fluid blade rotary shaft 34 in a top view.

The gate blade 18 that serves as an auxiliary blade or an inner blade having a smaller diameter than the fluid blade 14 is installed on the central side or inner side of the fluid blade 14 in the radial direction. The gate blade 18 is driven to be rotated about the gate blade rotary shaft 52 by the gate blade driving unit to make the fluid flow in the stirring tank 12 in an aspect different from that of the fluid blade 14 inside the fluid blade 14. In addition, the shear blade 16 (which will be described below) is installed below the gate blade 18. Therefore, the distance between the bottom portion 22 of the stirring tank 12 and the gate blade 18 (a lower member 48D which will be described below) in the axial direction is larger than an installation space or installation height of the shear blade 16. In other words, a space below the gate blade 18 can be fully utilized by the shear blade 16.

The gate blade 18 includes a gate blade body 48 that has a rectangular frame shape and is line-symmetric with respect to the rotary shaft (gate blade rotary shaft 52) in the vertical direction and the gate blade rotary shaft 52 in the axial direction that is connected to an upper portion of the gate blade body 48 and is driven to be rotated by the gate blade driving unit (not shown). The gate blade body 48 has a frame structure in which an upper member 48U in the radial direction, a left member 48L in the axial direction, a right member 48R in the axial direction, and a lower member 48D in the radial direction each of which is formed in a rod shape or a columnar shape and which are integrated into a rectangular shape. The gate blade 18 is rotated in any direction and at any speed. However, typically, the gate blade 18 is rotated in an opposite direction to the fluid blade 14 or is rotated in the same direction as the fluid blade 14 at a different speed or a different number of rotations from the fluid blade 14.

Since the fluid blade 14 and the gate blade 18 are rotated in different directions and/or at different speeds, there is a difference between a movement speed of the object to be stirred associated with the rotation of the fluid blade 14 and a movement speed of the object to be stirred associated with the rotation of the gate blade 18. Therefore, it is possible to suppress “corotation” in which the object to be stirred in the stirring tank 12 is rotated together with the fluid blade 14, and the object to be stirred efficiently flows in the stirring tank 12. Further, the rotation direction and/or rotation speed of the gate blade 18 is appropriately set, which makes it possible to generate a flow that make the object to be stirred, which has been sheared by the shear blade 16 below the gate blade 18, flow upward. The induced flow that has been generated by the gate blade 18 to be directed upward in the central portion of the stirring tank 12 in this way is changed into an induced flow directed downward along the side wall 12a of the stirring tank 12 by the fluid blade 14 and is directed to the shear blade 16 again. Since the flow that circulates among the fluid blade 14, the shear blade 16, and the gate blade 18 is formed in this way, it is possible to efficiently stir the object to be stirred.

The shear blade 16 as the stirring blade provided between the bottom portion 22 of the stirring tank 12 and the fluid blade 14 is rotated about the shear blade rotary shaft 46 by the shear blade driving unit 47 to shear or stir the fluid in the stirring tank 12. The shear blade 16 includes a pair of blade portions 17A and 17B (hereinafter, collectively referred to as a blade portion 17) extending in the radial direction from the shear blade rotary shaft 46 to the side wall 12a of the stirring tank 12.

The blade portion 17 is disposed in a central region that is closer to the central side or the inner side than the lower end portion of the fluid blade 14 rotated in the outer peripheral region of the stirring tank 12 or the bottom portion 22 in the radial direction (left-right direction). Therefore, at least a portion (lower end portion) of the fluid blade 14 is rotated between a tip portion (a left end portion and a right end portion in FIG. 1) of the blade portion 17 and the side wall 12a of the stirring tank 12 without interfering with the blade portion 17. In addition, the blade portion 17 is disposed between the upper gate blade 18 and the bottom portion 22 of the lower stirring tank 12 in the axial direction (up-down direction). That is, the blade portion 17 is disposed in the central region facing the bottom portion 22 of the stirring tank 12. As described above, since the bottom portion 22 of the stirring tank 12 in the present embodiment has a planar shape, the shear blade 16 including the blade portion 17 that extends in the radial direction substantially parallel to the bottom portion 22 can be efficiently or compactly disposed in a substantially rectangular parallelepiped region that is surrounded by the upper gate blade 18, the fluid blade 14 (lower end portion) in the left-right direction, and the bottom portion 22 of the lower stirring tank 12.

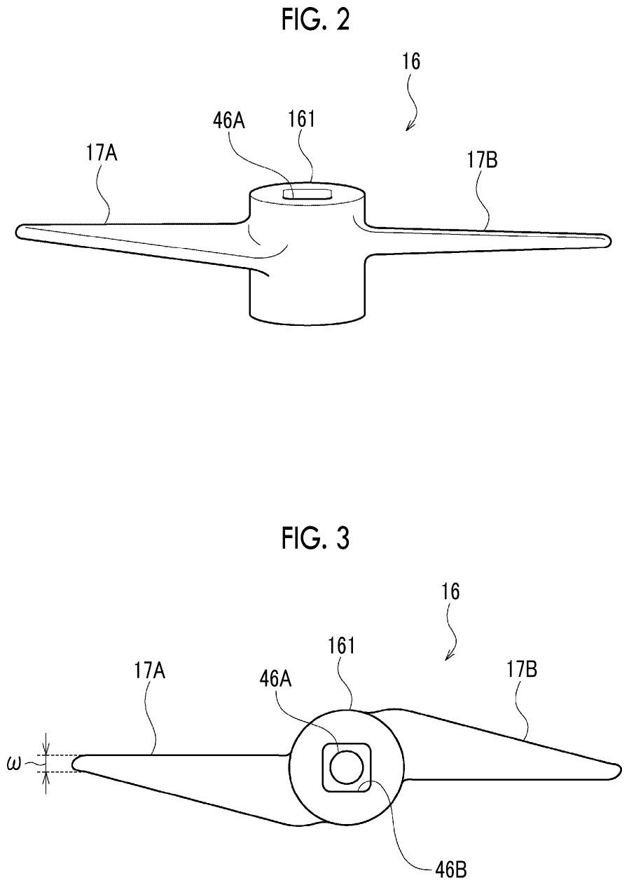

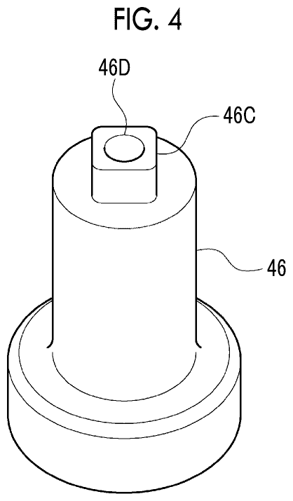

FIG. 2 is a perspective view showing the shear blade 16 as viewed from a substantially side surface, and FIG. 3 is a top view or a bottom view showing the shear blade 16. The shear blade 16 includes a cylindrical boss 161 in which the axial direction (up-down direction in FIG. 2) is a height direction and the pair of blade portions 17A and 17B (blade portion 17) extending from the boss 161 in the radial direction (left-right direction in FIGS. 2 and 3). An attachment hole 46A in the axial direction into which the shear blade rotary shaft 46 is inserted and attached is provided in a central portion of the boss 161 in the radial direction. As shown in FIG. 3, the attachment hole 46A is provided at a center of a recessed portion 46B that has a substantially rectangular or square cross section. In a case where the recessed portion 46B is provided in a lower surface of the boss 161, a protruding portion 46C (FIG. 4) that is engaged with or is fitted to the recessed portion 46B is provided on the upper end portion of the shear blade rotary shaft 46 having a substantially cylindrical shape. In a top view, the cross-sectional shape of the protruding portion 46C is a substantially rectangular shape or a substantially square shape and is a congruent shape with the cross-sectional shape of the recessed portion 46B or a similar shape that is slightly smaller than the cross-sectional shape of the recessed portion 46B. In addition, in a top view, an attachment hole 46D that communicates with the attachment hole 46A of the boss 161 is provided at a center of the protruding portion 46C. The shear blade rotary shaft 46 and the shear blade 16 (boss 161) are fixed by screws (not shown) that are fastened to the attachment hole 46A and the attachment hole 46D in a state in which the protruding portion 46C in the upper portion of the shear blade rotary shaft 46 is inserted into the recessed portion 46B in the lower portion of the boss 161. Therefore, the shear blade rotary shaft 46 and the shear blade 16 can be integrally rotated.

The blade portion 17 is fixed to the boss 161 by, for example, welding. In addition, the blade portion 17 may be directly fixed to the shear blade rotary shaft 46 by welding or the like, without using the boss 161. A normal direction of a stirring surface (surface) of each of the plate-shaped blade portions 17A and 17B is inclined with respect to both the axial direction (the up-down direction in FIG. 2) of the shear blade rotary shaft 46 and the rotation direction (a rotation direction around the shear blade rotary shaft 46) of each of the blade portions 17A and 17B. The stirring blade or the shear blade including the blade portion 17 is sometimes referred to as an inclined paddle blade. For example, it is preferable that an angle formed between the normal direction of the stirring surface of each of the blade portions 17A and 17B and the axial direction of the shear blade rotary shaft 46 is equal to or less than 15 degrees (an angle formed with respect to the rotation direction of each of the blade portions 17A and 17B is equal to or greater than 75 degrees). As a result, the stirring surface of each of the blade portions 17A and 17B is substantially parallel to the bottom portion 22 of the stirring tank 12 (the angle is equal to or less than 15 degrees). Therefore, the fluid resistance of the stirring surface during rotation is reduced. Therefore, it is possible to drive the blade portion 17 with a relatively low power even when the diameter of the blade portion 17 is increased, and it is possible to prevent an increase in the size or cost of the shear blade driving unit 47. In addition, since the blade portion 17 is inclined as described above, the blade portion 17 is less likely to idle even in a case where a high-thixotropy fluid or a low-spinnability fluid is used. Therefore, shearing efficiency or refinement efficiency is improved.

Since the shear blade 16 or the blade portion 17 having a non-disc shape has a relatively small load power, it is possible to increase the blade diameter. In addition, since the shear blade 16 or the blade portion 17 is light in weight, it is easy to maintain a rotational balance. Therefore, the blade diameter of the blade portion 17 in the extension direction (the distance between the left end of the blade portion 17A and the right end of the blade portion 17B in the radial direction in FIGS. 2 and 3) can be set between 35% and 85% of the tank diameter D of the stirring tank 12, preferably between 45% and 75%, and more preferably between 50% and 70% of the tank diameter D of the stirring tank 12. Therefore, the shearing region can be larger than that in the disc-shaped stirring blade according to the related art, and the shearing efficiency or the refinement efficiency is improved.

In addition, in the disc-shaped stirring blade according to the related art (for example, the dispersion blade disclosed in Patent Literature 1), the inside of the stirring tank is divided into the upper and lower portions by the disc portion, which significantly hinders the flow of the fluid. As a result, particularly, in a high-viscosity solution, a liquid pool is likely to be formed on the lower side of the disc portion. In contrast, according to the present embodiment, since the non-disc-shaped shear blade 16 including the blade portion 17 that extends from the shear blade rotary shaft 46 to the side wall 12a of the stirring tank 12 is used, the stirring tank 12 is not divided into the upper and lower portions unlike the disc-shaped stirring blade according to the related art. Therefore, even when the blade diameter of the blade portion 17 of the shear blade 16 is increased, the flow of the fluid is not significantly hindered by the fluid blade 14 or the gate blade 18. As described above, the flow generated by the fluid blade 14 and the gate blade 18 can easily reach the shear blade 16 whose diameter can be increased as compared to the related art. Therefore, even a high-viscosity fluid is effectively sheared or stirred.

As described above, the shear blade 16 or the entire stirring device 10 according to the present embodiment is suitable for shearing or refining a fluid having a relatively high viscosity (a fluid having a viscosity of at least 1,000 cP or more, for example, a fluid having a viscosity of 10,000 cP or more). Any fluid (oil, varnish, rubber, a polymer solution, a molten resin, or the like) including fine particles of carbon black, silica, or the like is given as an example of the high-viscosity fluid. The fine particles of carbon black or the like form agglomerates in the fluid and are efficiently refined and/or dispersed by the shear blade 16 according to the present embodiment.

A width w (FIG. 3) of the tip portion of the blade portion 17 in the rotation direction is preferably equal to or less than 5% of the tank diameter D of the stirring tank 12 in order to obtain suitable shear performance or refinement performance for the high-viscosity fluid. A distance h (FIG. 1) between the blade portion 17 and the bottom portion 22 of the stirring tank 12 is preferably equal to or less than 15% of the tank diameter D of the stirring tank 12 in order to obtain the desired stirring performance in the bottom portion 22 of the stirring tank 12 in which the fluid to be stirred often settles and the discharge port through which the stirred fluid is discharged is often provided.

The present invention has been described above based on the embodiment. Combinations of the respective components and the respective processes in the embodiment as an example can be modified in various ways, and it is obvious to those skilled in the art that the modifications are included in the scope of the present invention.

For example, the shape of the stirring blade according to the present invention is not limited to the shape of the shear blade 16 shown in the embodiment. In order to obtain at least some of the effects of the present invention, the stirring blade provided between the bottom portion of the stirring tank and the fluid blade may have any non-disc shape including one or a plurality of blade portions that extend from the rotary shaft of the stirring blade to the side wall of the stirring tank.

In addition, the configuration, operation, and function of each device and each method described in the embodiment can be implemented by hardware resources or software resources, or by cooperation between the hardware resources and the software resources. For example, a processor, a ROM, a RAM, and various integrated circuits can be used as the hardware resources. For example, programs, such as an operating system and applications, can be used as the software resource.

It should be understood that the invention is not limited to the above-described embodiment, but may be modified into various forms on the basis of the spirit of the invention. Additionally, the modifications are included in the scope of the invention.

What is claimed is:

1. A stirring device comprising:
a stirring tank that accommodates a fluid;
a fluid blade that is rotated to make the fluid flow in the stirring tank; and
a stirring blade that is provided between a bottom portion of the stirring tank and the fluid blade, is rotated to stir the fluid, and includes a substantially-plate-shaped blade portion that extends from a rotary shaft of the stirring blade to a side wall of the stirring tank,
wherein a normal direction of a stirring surface of the substantially-plate-shaped blade portion is inclined with respect to both an axial direction of the rotary shaft and a rotation direction of the blade portion, and
a blade diameter of the substantially-plate-shaped blade portion in an extension direction is between 50% and 70% of a tank diameter of the stirring tank.

2. The stirring device according to claim 1,
wherein at least a portion of the fluid blade is rotated between a tip portion of the blade portion and the side wall of the stirring tank.

3. The stirring device according to claim 1,
wherein the stirring blade includes a boss,
the substantially-plate-shaped blade portion extends in a radial direction from the boss,
an attachment hole in the axial direction into which the rotary shaft is inserted and attached is provided in a central portion of the boss in the radial direction, and
the attachment hole is provided in a recessed portion having a rectangular or square cross section.

4. The stirring device according to claim 3,
wherein an angle formed between the normal direction of the stirring surface of the blade portion and the axial direction is equal to or less than 15 degrees.

5. The stirring device according to claim 1,
wherein a viscosity of the fluid is at least 1.000 cP or more.

6. The stirring device according to claim 1,
wherein a width of a tip portion of the blade portion is equal to or less than 5% of the tank diameter of the stirring tank.

7. The stirring device according to claim 1,
wherein a distance between the blade portion and the bottom portion of the stirring tank is equal to or less than 15% of the tank diameter of the stirring tank.

8. The stirring device according to claim 1,
wherein the bottom portion of the stirring tank has a substantially planar shape, and
the substantially-plate-shaped blade portion extends parallel to the bottom portion.

9. The stirring device according to claim 8,
wherein the planar bottom portion of the stirring tank is attachable to a flange portion that is formed in a bottom portion of a cylindrical side wall of the stirring tank.

10. The stirring device according to claim 1,
wherein the rotary shaft of the stirring blade extends from the bottom portion of the stirring tank into the stirring tank.

11. The stirring device according to claim 1,
wherein a rotary shaft of the fluid blade extends from a top portion of the stirring tank into the stirring tank.

12. The stirring device according to claim 1,
wherein a rotation speed of the stirring blade is higher than a rotation speed of the fluid blade.

13. The stirring device according to claim 1,
wherein the rotary shaft of the stirring blade and a rotary shaft of the fluid blade are provided on substantially the same straight line.

14. A stirring method comprising:
rotating a fluid blade to make a fluid flow in a stirring tank; and
rotating a stirring blade, which is provided between a bottom portion of the stirring tank and the fluid blade and includes a substantially-plate-shaped blade portion that extends from a rotary shaft of the stirring blade to a side wall of the stirring tank, at a higher speed than the fluid blade to stir the fluid,
wherein a normal direction of a stirring surface of the substantially-plate-shaped blade portion is inclined with respect to both an axial direction of the rotary shaft and a rotation direction of the blade portion, and
a blade diameter of the substantially-plate-shaped blade portion in an extension direction is between 50% and 70% of a tank diameter of the stirring tank.
